(19) United States
(12) Patent Application Publication
(10) Pub. No.: US 2008/0202875 A1
(43) Pub. Date: Aug. 28, 2008

(54) Spring-Damper Device for Motor Vehicles, and Level-Regulating System for Motor Vehicles

(75) Inventor: Jürgen Siebeneick, Oberwesel (DE)

Correspondence Address: INGRASSIA FISHER & LORENZ, P.C., 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 11/574,712

(22) PCT Filed: Aug. 30, 2005
(86) PCT No.: PCT/EP05/09306

§ 371 Date: Sep. 4, 2007

(30) Foreign Application Priority Data
Sep. 3, 2004 (DE) 10 2004 042 711.9

(51) Int. Cl. B60G 17/015; F16F 9/092; B60G 17/048

(52) U.S. Cl. 188/298; 267/64.16

(57) ABSTRACT

The invention relates to a spring damper facility for a motor vehicle and a level control system for a motor vehicle. The spring damper facility has a main hydraulic volume and a pneumatic volume separated from the main hydraulic volume interacting with the main hydraulic volume. According to the invention, a decentralised hydraulic compensation volume is present in the spring damper facility, wherein hydraulic fluid from the hydraulic compensation volume can be redirected into the main hydraulic volume and vice versa to change a load carrying capacity of the spring damper facility and thus to provide a change in height or a change in level for the motor vehicle.

The invention relates to a spring damper facility for a motor vehicle, with a main hydraulic volume and with a pneumatic volume separated from the main hydraulic volume acting together with the main hydraulic volume. Moreover, the invention relates to a level control system for a motor vehicle with several such hydropneumatic spring damper facilities.

To improve the ride comfort, chassis of motor vehicles were increasingly further developed in the past. Thus, active chassis are known from the prior art. With such active chassis, chassis systems are automatically adapted to the respective driving conditions by way of a control circuit. The vehicle systems adaptable with the help of an active chassis for instance are spring damper systems, level control systems and/or stabilisation systems of the chassis.

Various spring damper facilities and level control systems are known from the prior art. DE 36 19 777 A1 for example shows a level control facility for motor vehicles which comprises several hydraulic cylinders, wherein the hydraulic cylinders are interconnected with one another and with a central tank by way of hydraulic lines.

EP 0 686 518 B1 discloses a pneumatic level control system with air suspension elements which are connected with one another by way of pneumatic lines and with a central compressor.

Based on this, the present invention is based on the problem of creating a new type of spring damper facility and a new type of level control system for a motor vehicle.

This problem is solved in that the spring damper facility mentioned at the outset decentrally has a hydraulic compensation volume wherein hydraulic fluid from the hydraulic compensation volume can be redirected into the main hydraulic volume and vice versa to change a load carrying capacity of the spring damper facility and thus provide a change in height or a change in level for the vehicle. The main hydraulic volume, the pneumatic volume and the hydraulic compensation volume are preferably an integral part of the spring damper facility.

With such a spring damper facility the installation of hydraulic lines and pneumatic lines between individual spring damper facilities and thus within the motor vehicle and across through the said motor vehicle can be omitted. The design effort is reduced as a result. Level control systems with such spring damper facility can be integrated in motor vehicles with considerably lower costs and in a more space-saving way.

Preferably the main hydraulic volume, the pneumatic volume and the hydraulic compensation volume are integrated in a common housing so that each wheel of a vehicle can be decentrally assigned such a spring damper facility without hydraulic and pneumatic connections between the individual spring damper facilities.

The level control system according to the invention is characterized through the features of Patent claim 8.

The level control system according to the invention has several hydropneumatic spring damper facilities, wherein a hydropneumatic spring damper facility is assigned to each wheel. Each spring damper facility has a decentralised main hydraulic volume, a hydraulic compensation volume and a pneumatic volume. The hydraulic compensation volume of a spring damper facility is in connection with the main hydraulic volume of this spring damper facility. Hydraulic fluid from the hydraulic compensation volume can be redirected into the main hydraulic volume and vice versa to provide a change in height or a change in level for the vehicle.

The level control system according to the invention has a central control or regulating device, wherein all spring damper facilities and the level sensors assigned to the spring damper facilities are connected with the central control or regulating device by way of control lines.

Preferred further developments of the invention are obtained from the dependent sub-claims and the following description.

In the following, an exemplary embodiment of the invention is explained in more detail, without being restricted to the same, making reference to the drawing. In the drawing it shows:

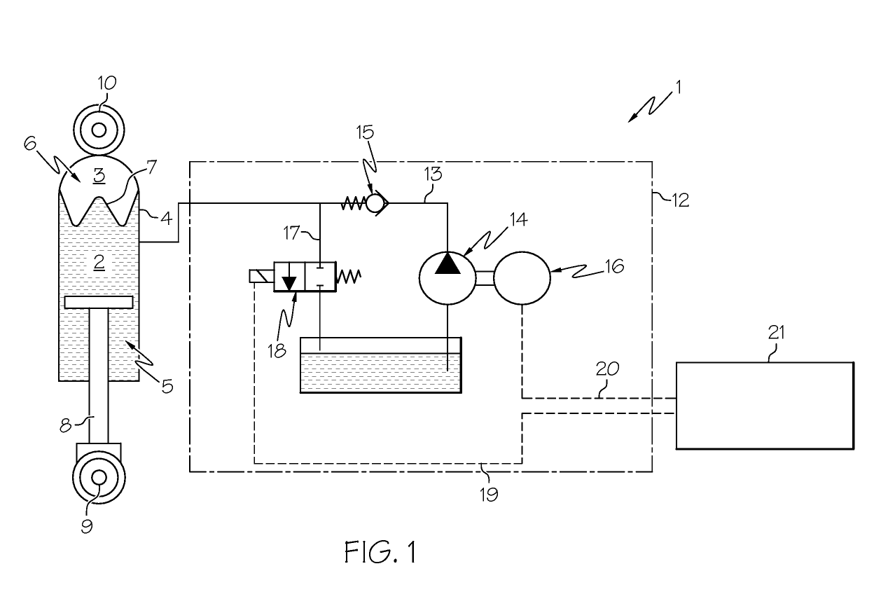

FIG. 1 a schematic block circuit diagram of a spring damper facility according to the invention,

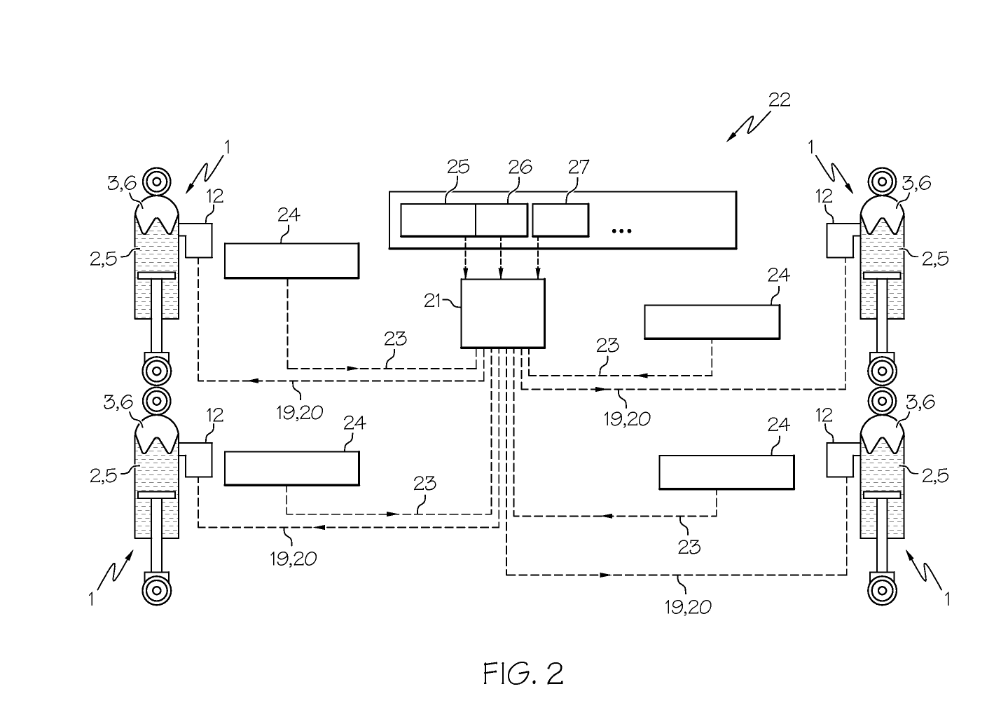

FIG. 2 a schematic block circuit diagram of a level control system according to the invention with several spring damper facilities according to the invention according to FIG. 1, and

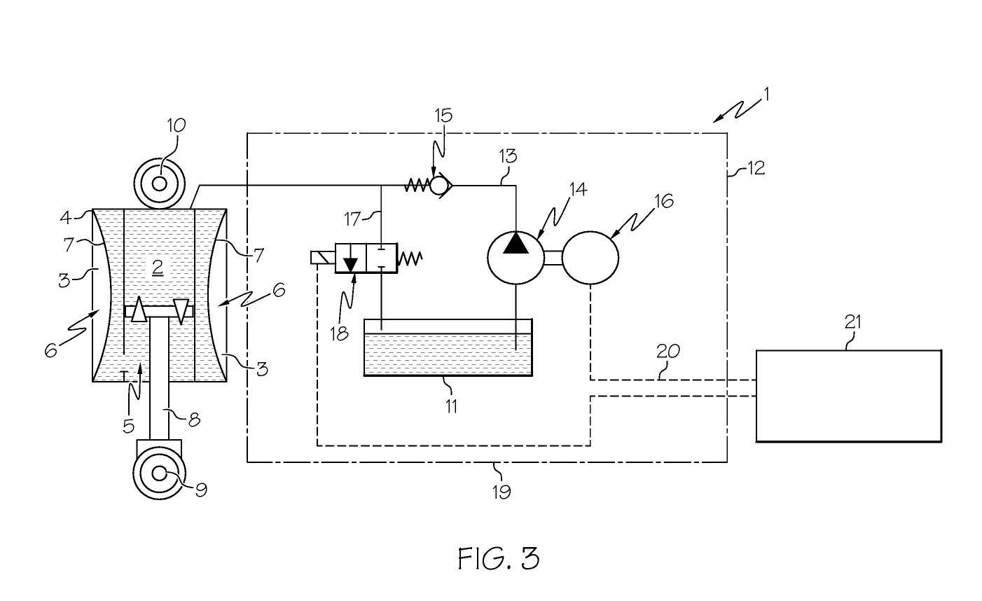

FIG. 3 a schematic block circuit diagram of a spring damper facility according to the invention, which has been modified relative to the embodiment according to FIG. 1.

The invention is described in greater detail in the following making reference to FIGS. 1 and 2.

FIG. 1 shows a spring damper facility 1 according to the invention, wherein such a spring damper facility 1 can be decentrally assigned to each wheel of a motor vehicle. FIG. 1 is a greatly schematised presentation of the spring damper facility 1 according to the invention in form of a block circuit diagram.

According to FIG. 1 for instance the spring damper facility 1 according to the invention has a main hydraulic volume 2 and a pneumatic volume 3 separated from the main hydraulic volume 2 interacting with the main hydraulic volume 2. The main hydraulic volume 2 and the pneumatic volume 3 are arranged in a common housing 4. Accordingly, an accommodation chamber 5 for the main hydraulic volume 2 and an accommodation chamber 6 for the pneumatic volume 3 are arranged within the housing 4. The accommodation chamber 5 accommodating the main hydraulic volume 2 and the accommodation chamber 6 accommodating the pneumatic volume 3 are separated from each other through a flexible separating wall or diaphragm 7. A piston rod 8 protrudes into the accommodation chamber 5 accommodating the main hydraulic volume 2. The piston rod 8 has a piston 28 at the end facing the engine compartment 7. The piston 28 has a throttle valve acting in both directions which is not shown here so that the main hydraulic volume 2 is separated into an upper and a lower main hydraulic volume. Alternatively, the throttle valve can also be arranged externally and is connected with the upper and lower main hydraulic volume. The piston rod 8 at the lower end of the housing 4 protrudes from the latter and at its free end protruding from the housing 4 has a mounting element 9. Opposite this mounting element 9 a further mounting element 10 is provided at the upper end of the housing. By way of the mounting elements 9 and 10 the spring damper facility 1 according to the invention can be integrated in a motor vehicle.

The intention of the present invention now is that each spring damper facility 1 has a decentralised hydraulic compensation volume 11. To explain the operation of the spring damper facility 1 according to the invention the hydraulic compensation volume 11 in FIG. 1 is arranged outside the housing 4. It is however preferable that the hydraulic compensation volume 11 together with all other components which in FIG. 1 are framed by the box 12 marked with the reference number 12 are integrated in the housing 4 of the spring damper facility 1 according to the invention.

From the hydraulic compensation volume 11 hydraulic fluid can be redirected into the main hydraulic volume 2 and vice versa. Through the redirecting of hydraulic fluid between the main hydraulic volume 2 and the hydraulic compensation volume 11 the load carrying capacity of the spring damper facility 1 according to the invention is adjustable. As a result, a change in height or a change in level for a motor vehicle in which such a spring damper facility 1 is integrated can be made available.

The hydraulic compensation volume 11 is in connection with the main hydraulic volume 1 by way of hydraulic lines. In this way, a controllable pumping device 14 and a non-return valve 15 are integrated in a first hydraulic line. The pumping device 14 is controlled by way of a pump motor 16 assigned to the pumping device 14. By way of the pumping device 14 hydraulic fluid can be redirected from the hydraulic compensation volume 11 into the main hydraulic volume 2. The non-return valve 15, which in pumping direction of the hydraulic fluid is arranged behind the pumping device 14 in the first hydraulic line 13 prevents that hydraulic fluid from the main hydraulic volume 2 is able to flow back into the hydraulic compensation volume 11. In parallel with this first hydraulic line 13 a second hydraulic line 17 is arranged, wherein this second hydraulic line 17 likewise serves to connect the hydraulic compensation volume 11 with the main hydraulic volume 2. A controllable drain valve 18 is integrated in this second hydraulic line 17. According to FIG. 2 the controllable drain valve 18 has two switching stages. In a first switching stage the second hydraulic line 17 is interrupted so that no hydraulic fluid is able to flow through said line. In a second switching stage however the second hydraulic line 17 and the flow of hydraulic fluid through said line is enabled.

It is pointed out once more at this point that the main hydraulic volume 2, the pneumatic volume 3 and the hydraulic compensation volume 11 are decentrally provided in each spring damper facility 1 and are preferably integrated in the common housing 4 of the spring damper facility 1 together with the hydraulic lines and the assemblies (pumping device 14, non-return valve 15, motor 16 as well as drain valve 18) integrated in the hydraulic lines. Since the hydraulic compensation volume 11 is decentrally made available in each spring damper facility 1 no connections among individual spring damper facilities 1 via hydraulic lines are required. In addition, the connection of the spring damper facilities 1 with a central hydraulic volume can be omitted.

If lifting of a motor vehicle is now to be realised with the spring damper facility 1 according to the invention shown in FIG. 1, hydraulic fluid from the hydraulic compensation volume 11 is pumped via the pumping device 14 into the main hydraulic volume 2 by way of the first hydraulic line 13, whereas the second hydraulic line 17 is interrupted. Through the supply of hydraulic fluid from the hydraulic compensation volume 11 into the main hydraulic volume 2 the pressure within the main hydraulic volume 2 is increased as a result of which a greater load carrying capacity can be achieved for the spring damper facility 1. This causes the motor vehicle to be lifted. If the motor vehicle however is to be lowered, the drain valve 18 is moved to the open position with the pumping device 14 switched off so that hydraulic fluid is able to flow from the main hydraulic volume 2 into the hydraulic compensation volume 11 through the second hydraulic line 17. This causes the pressure within the main hydraulic volume 2 to be reduced. This causes the load carrying capacity to be reduced and the motor vehicle is lowered.

It is pointed out that the spring damper facility 1 can be embodied as both part-carrying as well as fully carrying hydropneumatic spring damper element. In the case that the spring damper facility 1 is embodied as a fully carrying element said element absorbs the entire load of the motor vehicle together with further spring damper facilities 1 of the same type that may be assigned to other wheels of the motor vehicle. With a part-carrying spring damper facility 1 an additional spring element is preferably present on each wheel of the motor vehicle in addition to the said facility, which in addition to the spring damper facility 1 provides a second load path and accommodates a part of the load of the motor vehicle.

As is likewise evident from FIG. 1, the controllable drain valve 18 and the controllable pumping device 14 and the motor 16 of said pumping device are connected with a control or regulating device 21 via control lines 19, 20. The control or regulating device 21 is designed as a central control or regulating device 21 with which all spring damper facilities 1 present in a motor vehicle are connected by way of suitable control lines. The drain valve 18 and the pumping device 14 of each spring damper facility 1 can be controlled by way of this control or regulating device 21 to guarantee a change in height or a change in level for the motor vehicle.

FIG. 2 shows a level control system 22 according to the invention. With the level control system 22 according to the invention a spring damper facility 1 according to the invention is assigned to each wheel of a motor vehicle. The block circuit diagram of the level control system 22 shown in FIG. 2 is thus a level control system for a two-axle motor vehicle with four wheels. The spring damper facilities 1 shown on the left side of FIG. 2 are assigned to the two wheels of a front axle, the spring damper facilities 1 shown on the right side are assigned to the two wheels of a rear axle of a motor vehicle. Accordingly, a main hydraulic volume 2, a hydraulic compensation volume 11 and a pneumatic volume 3 are decentrally available on each wheel of the motor vehicle. No connections whatsoever among the decentralised spring damper facilities 1 on the one hand and with a central hydraulic volume and/or pneumatic volume on the other hand are required. The sole connection of the spring damper facilities 1 with a central facility is the connection of said facilities with the central control or regulating device 21 by way of the control lines 19 and 20.

According to FIG. 2 each spring damper facility 1 is assigned a height sensor 24. The height sensor 24 can either be integrated in the spring damper facility 1 or designed as a separate assembly. Each height sensor 24 is connected with the central control or regulating device 21 by way of control lines 23. The height sensors 24 record the current height or the current level on each wheel of the motor vehicle and transmit a corresponding measurement as input variable for the control or regulating device.

In addition to the height sensors 24 the control or regulating device 21 is connected with further sensors the measurements of which serve as input variables for the control or regulating device 21. These sensors can for instance be a speed sensor 25, an acceleration sensor 26 and a steering wheel angle sensor 27. The points shown next to the sensors 25, 26 and 27 serve to illustrate that additional sensors can also provide measurements to the control or regulating device 21 as input variables.

The control or regulating device 21 determines output variables as function of the measurements of the height sensors 24 and the sensors 25, 26 and 27 by means of a regulating law loaded in the control or regulating device 21 which serve as control variables for the spring damper facilities 1. These control variables are supplied to the spring damper facilities 1 by way of the control lines 19 or 20.

In terms of the present invention a level control system 22 is thus suggested which comprises several decentralised spring damper facilities 1. The decentralised spring damper facilities 1 decentrally comprise, i.e. each separately for itself, a main hydraulic volume 2, the hydraulic compensation volume 11 and the pneumatic volume 3. Linking the spring damper facilities 1 is merely effected by way of electric control lines with a central control or regulating device 21.

Accordingly, a cost effective level control system can be provided with the help of the invention. No installation of hydraulic lines and/or pneumatic lines is required between the individual spring damper facilities or with a central hydraulic volume. Accordingly, the level control system according to the invention can be integrated in a motor vehicle in a space saving and cost effective manner. With the help of the level control system according to the invention and the spring damper facilities according to the invention, different levels can be easily realised for a motor vehicle. In this way, depending on the speed of the motor vehicle, the level of the motor vehicle can be lowered to reduce fuel consumption. During parking, the level of the motor vehicle can likewise be adjusted to facilitate entering or exiting.

The spring damper facility according to the embodiment according to FIG. 3 differs from that according to FIG. 1 in that instead, based on the longitudinal direction of the spring damper facility, main hydraulic volumes 2 and pneumatic volumes 3 being arranged one behind the other, the pneumatic volume 3 is arranged concentrically to the longitudinal axis around the hydraulic volume 2. This concentric gas cushion can be part-carrying or fully carrying. As a matter of principle, the gas volume could also be positioned externally as a spring ball or a spring cylinder with a short connecting line. Components of the embodiment according to FIG. 3 corresponding with the embodiment according to FIG. 1 have been marked with the same reference numbers for simplification.

### LIST OF REFERENCE NUMBERS

Spring damper facility 1
Main hydraulic volume 2
Pneumatic volume 3
Housing 4
Accommodation chamber 5
Accommodation chamber 6
Separating wall 7
Piston rod 8
Mounting element 9
Mounting element 10
Hydraulic compensation volume 11
Box 12
Hydraulic line 13
Pumping device 14
Non-return valve 15
Motor 16
Hydraulic line 17
Drain valve 18
Control line 19
Control line 20
Control or regulating device 21
Level control system 22
Control line 23
Height sensor 24
Speed sensor 25
Acceleration sensor 26
Steering wheel angle sensor 27
Piston 28

1. A spring damper facility for a motor vehicle with a main hydraulic volume and with a pneumatic volume separated from the main hydraulic volume interacting with the hydraulic volume, characterized in that a decentralized hydraulic compensation volume, wherein hydraulic fluid from the hydraulic compensation volume can be redirected into the main hydraulic volume and vice versa to change a load carrying capacity of the spring damper facility and thus provide a change in height or a change in level for the motor vehicle.

2. The spring damper facility according to claim 1, wherein the hydraulic compensation volume is in connection with the main hydraulic volume and that a controllable pumping device serves to redirect hydraulic fluid.

3. The spring damper facility according to claim 2, wherein the hydraulic compensation volume is in connection with the main hydraulic volume by way of hydraulic lines, wherein the controllable pumping device together with a non-return valve is arranged in a first hydraulic line, and wherein a controllable drain valve is arranged in a second hydraulic line.

4. The spring damper facility according to claim 3, wherein the controllable pumping device and the controllable drain valve are connected with a control or regulating device by way of control lines.

5. The spring damper facility according to claim 1, wherein the pneumatic volume is arranged concentrically around the hydraulic volume.

6. The spring damper facility according to claim 1, wherein the main hydraulic volume, the pneumatic volume and the hydraulic compensation volume are integral parts of the spring damper facility so that such a spring damper facility without hydraulic and pneumatic connections between the individual spring damper facilities can be assigned to each wheel of a motor vehicle.

7. The spring damper facility according to claim 1, wherein the said facility is designed as decentralised, hydropneumatic spring damper facility, wherein such a spring damper facility is decentrally assigned to each wheel of a motor vehicle and wherein all spring damper facilities are connected with a central control or regulating facility by way of control lines.

8. A level control system for a motor vehicle with several hydropneumatic spring damper facilities, wherein each spring damper facility decentrally has a main hydraulic volume, a hydraulic compensation volume and a pneumatic volume, wherein the hydraulic compensation volume of a spring damper facility is in connection with the main hydraulic volume of this spring damper facility, wherein hydraulic fluid can be redirected from the hydraulic compensation volume into the main hydraulic volume and vice versa to make available a change in height or a change in level for the motor vehicle.

9. The level control system according to claim 8, wherein a spring damper facility is assigned to each wheel of the motor vehicle.

10. The level control system according to claim 8, wherein a height sensor is assigned to each spring damper facility.

11. The level control system according to claim 8, wherein a central control or regulating device, wherein all spring damper facilities and all height sensors are connected with the central control or regulating device by way of control lines.

12. The level control system according to claim 11, wherein measurements of the height sensors are input variables for the control or regulating device.

13. The level control system according to claim 11, wherein a speed sensor and/or an acceleration sensor and/or a steering wheel angle sensor is/are connected with a control or regulating device, wherein the measurements of these sensors are additional input variables for the control or regulating device.

14. The level control system according to claim 11, wherein the control or regulating device generates output variables dependent on the input variables, wherein the output variables are control signals for the spring damper facilities.

15. The level control system according to claim 8, wherein with each decentralised decentralized spring damper facility the hydraulic compensation volume is in connection with the main hydraulic volume, and that a controllable pumping device serves to redirect the hydraulic fluid.

16. The level control system according to claim 15, wherein with each decentralized spring damper facility the controllable pumping device together with a non-return valve is arranged in a first hydraulic line, and that a controllable drain valve is arranged in a second hydraulic line.
